(19) United States
(12) Patent Application Publication
(10) Pub. No.: US 2015/0284985 A1
(43) Pub. Date: Oct. 8, 2015

(54) Gun Safe Handle Assembly System and Method

(71) Applicant: Patrick Muir, Tempe, AZ (US)

(72) Inventor: Patrick Muir, Tempe, AZ (US)

(21) Appl. No.: 14/596,562

(22) Filed: Jan. 14, 2015

Related U.S. Application Data
(60) Provisional application No. 61/927,224, filed on Jan. 14, 2014.

(51) Int. Cl. E05G 1/02; F41C 33/06; A47B 81/00; E05G 1/04; E05G 1/026

(52) U.S. Cl. CPC E05G 1/02; E05G 1/04; E05G 1/026; A47B 81/005; F41C 33/06

(57) ABSTRACT

A gun safe handle assembly system and method including a universal pin for attaching to standard types of gun safe handle hubs via threaded screw-in, the pin extended there beyond to form a handle, or otherwise to house an ornamental handle that would be mounted upon the extended portion of the pin. Ornamental handles may be attached by crimping, set screw, silicon/glue, or other fastener methods, or via screw-in, preferably in the opposite thread direction to allow a single twisting direction to accomplish tightening.

### CLAIM OF PRIORITY

The present application is related to and claims priority from prior provisional application Ser. No. 61/927,224, filed Jan. 14, 2014 which application is incorporated herein by reference.

### TECHNICAL FIELD

Aspects of this document relate to gun safes and gun safe accessories. More particularly, aspects relate to gun safe access handles.

### BACKGROUND

A gun safe is the best way to assure that firearms will never be used by anyone other than their owners or those who are authorized to use them. Obviously, this includes intruders, who will often target loose firearms in home burglaries. Gun safes are strong and durable, and their design and locking mechanisms will prevent them from being pried open. Attached to or placed in a wall or floor, a gun safe will prevent a legally-owned weapon from being stolen and used for illegal purposes.

Beyond protecting weapons from theft, safes can protect others in the family, especially children, from the guns themselves. There is nothing more enticing to small children than a shiny firearm, and a dresser drawer may not be sufficient to keep a weapon away from them. Those who have weapons for protection may keep them loaded, and a child with a loaded gun is a recipe for tragedy. Parents can even be held responsible if their child harms others with the family gun. However, a gun safe that can only be opened with an entry code will guarantee that the children in the house will never touch a weapon except in the presence of the owner.

Gun safes can protect weapons from many outside threats, including fires and floods. Fire-resistant safes will protect their contents in all but the worst disasters, and some safes come with small heaters designed to reduce inside moisture that can lead to the accumulation of rust on a firearm. Some gun owners store their ammunition in safes with their weapons to assure that neither the weapons nor the bullets they use will fall into the wrong hands. Their durability makes gun safes an ideal place for storing other things as well, including jewelry and family heirlooms

Modern gun safes have practical purposes, but they can also enhance the appearance of the rooms in which they are placed. Some safes feature glossy or embroidered surfaces, which make them merely another piece of furniture in the hall or bedroom. There are many reasons to have one, but the peace of mind that comes with it is reason enough to have a gun safe

Gun safes with a carved wood exterior (furniture safes) serve a primarily decorative purpose and resemble old gun cabinets used for displaying weapons in the past. Design characteristics may include wood veneer and very thick tempered glass.

Electronic locks as well as mechanical locks are available on many models of safes. The highest reliability exists for mechanical locks, although they are often more time consuming to open than electronic locks. Some mechanical combination locks have key locks, too, that lock the combination lock dial from turning, thereby precluding casual attempts by anyone with physical access to the safe from trying multiple combinations in the hopes of unlocking the safe.

Some safes use live locking bolt technology and pry resistant metal to ensure the secure protection of its contents. Some safes provide only protection against burglary and unwanted access from young family members, while other safes provide additional protection against fire and flood and other natural disasters.

It is well known in the art to include rotating handles on gun safes. A central axle fits onto the face of many gun safes. As a handle locking mechanism is released, the axle is free to rotate and thereby trigger release of the locking or retraction of the door securing mechanism(s).

Gun safe access hub-axles are often connected to handles that allow for a person to easily apply torque pressure to turn the axle and thus open the safe door lock(s).

Typical arrangements of gun safe door handles include emanating spokes, often three or five, that allow handling when the spokes are at any angle.

In the past, handles have defaulted to cylindrical spokes about eight to sixteen inches. It is now preferable to enhance the ornamental see U.S. Design Patent No. USD692205 to Muir (incorporated herein by reference).

While an original manufactured handle assembly is preferred for gun safe owners who know exactly how they want to ornament the gun safe, and thus room, at the time of purchase and choice. However, owners who want to retrofit, or otherwise interchange handle assemblies for ornamental purposes require an alternative looks.

Interchangeable handles are known in unrelated product types, and unrelated arts. For instance, golf clubs with interchangeable handles allow the user to take a single handle and use it with multiple golf club heads, or to augment the angle of attachment with the head to allow for personalization of the head. Sink and faucet handles may also be constructed to allow for ease of assembly by attaching the handles once the mechanism has been installed. Interchangeable handles have also used a threaded mating technique, such as in the use for interchangeable handles for umbrellas and the like.

Bullet cartridge shell, are often available at low cost from government surplus. Some, such as the .50 caliber bullet or larger, make for useful handles. Certain used shells include defects including cracks, voids, inclusions, and incipient splits which make them inoperable for their primary purpose. By cleaning used shells of primer, sealant, powder residue, soot or carbon, by use of a steel brush, brass polish or tumbler to shiny, the (often brass) casings can be used for decorative or alternative purposes.

It is therefore an object of embodiments to provide a replaceable handle system for a gun safe.

It is a further object of embodiments to provide an easy replacement mode for changing out a handle for a gun safe.

It is yet another object of embodiments to provide a system of gun safe handles for ornamentation.

It is still yet another object of embodiments to provide option for standard or original manufactured gun safes to include replacement ornamented or ergonomic handles.

### SUMMARY

This document discloses improvements for gun safe, and particularly provides added flexibility and replacement ornamentation for gun safe handles. Embodiments include a gun safe for storing firearms and other valuables having a regular, standard, or unusual door opening for access to the interior. The door includes a locking mechanism for locking and unlocking said safe door, whereby turning a handle around a fixed axis, such as a hub, activates the locking mechanism (typically hidden within the door or door frame. When the axis extends beyond the face of the door, it includes a hub whereby a handle can be attached. Typically, the handles are screwed onto the hub in one or more locations with either a fixed metric or American size and threading system. The hub has female cavities to mate with the handle extending threaded member.

In embodiments, the handle includes a base pin, the base pin including at least that male threaded portion and a shaft, to support the handle, or act as the handle alone. Where the pin meets the hub, there is a portion exposed beyond the hub called a neck. In one embodiment, the neck is covered by a second piece, called a cover piece or a hollow cylindrical sleeve. The cylindrical sleeve may be colored to resemble a bullet as either copper for a full metal jacket, gray for a lead bullet, both for a partial jacket, or may have varied decorations to denote the sides of a hollow-point and other bullet types know in the art. This sleeve can be compressed, or cinched, onto the pin.

In an alternative embodiment, a third piece, typically ornamental or functional, will have a wider diameter than the sleeve, and will fit over the sleeve. The wider diameter may also extend along the pin to provide for a better ergonomic grip. The third piece may be a bullet casing, or other ornamentation. When a bullet casing is used, it is preferable to use a recycled, repurposed, or used actual bullet casing. In one embodiment, the pin shaft extends throughout the third piece, bullet casing, and extends through the round aperture in the back of the bullet casing normally used for primer. In such a way, with colors, and shape (preferably with an indent to indicate used bullet), the pin back end looks like the primer portion on the back face of the bullet casing, preferably of a center-fire bullet. Pushed onto the pin just enough to mimic this bullet with primer, the bullet front end (which is over the sleeve piece) is cinched over the sleeve to conform to the sleeve and the pin, preferably at the pin neck. The pin neck may have a wider diameter than the pin shaft to affect a proper cinch.

In an alternative embodiment, instead of, or in addition to a cinch, the handle cover piece or third piece includes side perpendicular access shafts to allow for a small set screw to go through the handle side (preferably underside) to affix the handle on to the pin with the screw pressure. The shafts would be threaded in embodiments to work with the set screws. The pin shaft may include flat surfaces to accommodate the set screw and provide additional contact surface area.

In an alternative embodiment, the handle cover piece may include a hollow shaft to accept at least a portion of the pin shaft; where by the pin has male threads which compliment threads on the interior of the handle hollow shaft to allow the handle to be screwed on the pin. Preferably, the thread direction is in the opposite direction as the handle pin in to the hub, to allow the handle pin and covering piece to be screwed in the same direction, commonly righty-tighty clockwise.

In an alternative embodiment, preferably reminiscent of the bullets above, the pin shaft may include a back end that looks like the bullet tip, i.e. in shape, preferably tapered, and/or in color, copper, etc. In this manner, the cover bullet casing handle portion would fit over pi shaft, back end first, so the bullet appears to be directed away from the hub. The bullet casing can be cinched, screwed, set screwed, or otherwise affixed to the pin.

Embodiments also utilize a method for producing these ornamental gun safe handles. The pin head is mated via threading into a gun safe rotating handle hub, while exposing at least a portion of the pin beyond the hub. A first sheath is then placed over at least a portion of the exposed pin. A second sheath is then placed over at least a portion of the first sheath. The second sheath is crimped, cinched, over the first sheath and onto the pin. The second sheath preferably covers at least a portion of the exposed pin. The first sheath may also be crimped/cinched directly onto the pin.

Embodiments also utilize a method of for producing these ornamental gun safe handles, whereby the pin is installed into a standard gun safe hub. An ornamental and/or ergonomic handle is positioned over the pin, and then screwed into the pin shaft. Alternative, set screws are used to set the handle onto the pin. The handle may be secured over the ornamental sheath over the pin via thread included within the ornamental sheath with complimentary threads on an exterior surface towards the distal end of the pin.

### DESCRIPTION OF THE DRAWINGS

Aspects of this document can be further illustrated through a description of certain embodiments.

FIG. 1 demonstrates a gun safe front portion having one of three potential handles attached.

FIG. 2 demonstrate the side view of a gun safe face hub without handle attachment

FIG. 3 demonstrates an exploded view of an embodiment including at left the hub and an embodiment of a pin.

FIG. 3A demonstrates the back end of an embodiment ornamental bullet handle.

FIG. 4 demonstrates a quasi-cross-section of an embodiment with ornamental handle attached to hub.

FIG. 5 demonstrates another embodiment in quasi-cross sectional demonstrating pin and handle with securing means.

FIG. 6 demonstrates an embodiment of a pin.

FIG. 7 demonstrates an embodiment of a pin.

FIG. 8 demonstrates an embodiment of a pin.

FIG. 9 demonstrates an embodiment of a pin shaft.

FIG. 10 demonstrates an embodiment of a pin shaft.

FIG. 11 demonstrates an embodiment of a pin shaft.

FIG. 12 demonstrates an embodiment of a pin.

FIG. 13 illustrates an embodiment of a pin.

FIG. 14 illustrates an embodiment of a pin with an ornamental handle thereon.

### DETAILED DESCRIPTION

The embodiments include a pin with threaded head that may be used for universal replacement of gun safe handles.

Generally, gun safe axles with multiple handles include a standard American or metric grade receiving thread bore of similar size. This ensures ease of handle assembly. The handles are often glued, siliconed, or otherwise set in place to avoid issues of handle loosening. Handles are usually offset by a certain degree, i.e. 10 degrees, from the face of the gun safe door to allow for installation. Due to this method of handle assembly, handles have been made uniformly cylindrical so that all handles match when applied. To install an ornamental handle, even one that is not uniformly concentric or cylindrical requires additional mechanism for installation.

For this purpose, embodiments provide a means for installing oddly shaped ornamental handles and other ornamental handles onto pre-made gun safes and gun safe door face handle axles.

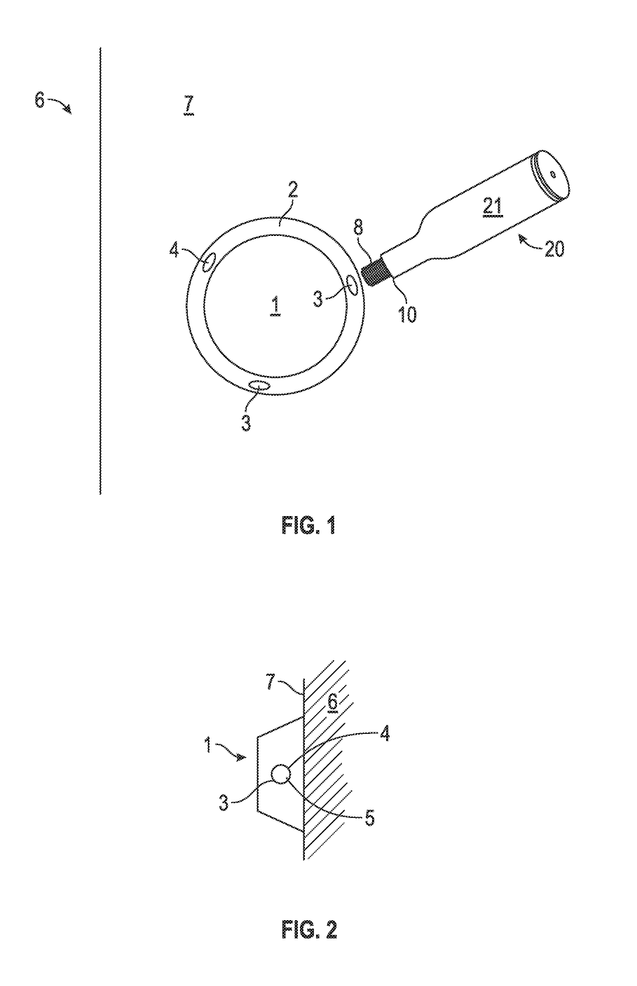

FIG. 1 illustrates an embodiment with an assembled bullet replica for handle. Gun safe 6 has door face 7. Axle hub 1 is generally placed centrally upon face 7, whereby a spoke or multiple spokes (typically 1, 3, or 5) emanate from the central hub 1. Specifically, spokes emanate from the hub edge 2. As shown in more detail in FIG. 2, hub edge 2 contains one or more mating surface 3 for pairing with a spoke. Recessed bore 4 is designed for receiving a bossed threaded male portion 8 from a male portion from a spoke. Bore 4 includes threads (not shown) for receiving a screw in the proper direction as known in the art to receive a male threaded member.

Typically, the hub edge includes a recessed threaded portion to mate with a male threaded portion for a handle piece (to act as spoke). In this case, the spoke takes the form of a bullet handle 20. Bullet handle 21 with bullet casing 20 serves as spoke.

FIG. 2 demonstrates the side of the hub 1 on gun safe 6 face 7. Hub includes side mating surface 3. On surface 3, recessed bore 4 allows for insertion of handle, or handle pin (not shown). Threads 5 within bore 4 allow for complimentary mating as is known in the art.

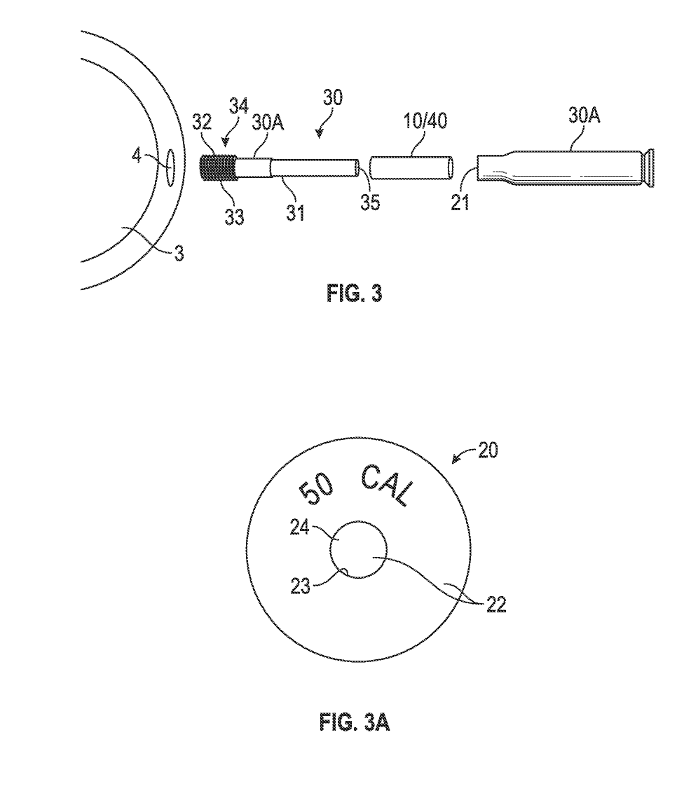

As seen in FIG. 3, directly apparent is bullet tip 10 which appears a polished shiny copper to emulate a copper encased (full metal jacket) lead bullet, typical of the .50 caliber bullets. FIG. 3 illustrates bullet 10 made from a copper tube portion forming a sleeve 40 to fit over pin 30 shaft 31 and head 34. Pin 30 may be manufactured by machining of aluminum, steel, plastic or any other material suitable for use as the center piece of a handle. Pin head 34 includes a threaded portion 32 and, in some embodiments, an unthreaded head portion 33. Sleeve 40 is meant to fit over, and conceal any/all parts of pin 30. Sleeve exposed portion would be the length of the exposed portion of a typical .50 caliber bullet, or less so, depending on ornamental embodiment, and pin 30 should extend longer than sleeve 40 in this embodiment. Shell casing 20 from a .50 caliber bullet is generally made of brass or other casing material and/or color known in the art. The materials for the pin, shell and sleeve may be any useful material to suit this purpose, may be painted to resemble the particular ornamental design required. However, in this preferred embodiment, actual polished and sealed copper is meant to replicate the full metal jacket and an actual shell casing of brass is used. In an alternative embodiment, the shell casing is repurposed from an actual bullet, possibly used.

Embodiments utilize a method of using repurposed used or new shell casings to create gun safe handles. When used in this fashion, pin 30 is mated into recessed bore 4, by inserting threaded portion 32 of head 34 into bore 4 via screwing/rotating pin 30 to mate the complementary threads. Sleeve 40 is slid over back end 35 of pin, over shaft 31 and over any remaining exposed portion of head 34. In the preferred embodiment, head 34 includes both a threaded portion 32 and unthreaded cylindrical portion 33, preferably of the same or similar diameter to threaded portion 32. Sleeve 40 covers neck 33 and any extending threaded portion 32, as well as a possible portion of shaft 31. Shell casing 20 slides over back 35 and over sleeve 40. Sleeve is preferably sized to just fit within shell casing forward opening 21.

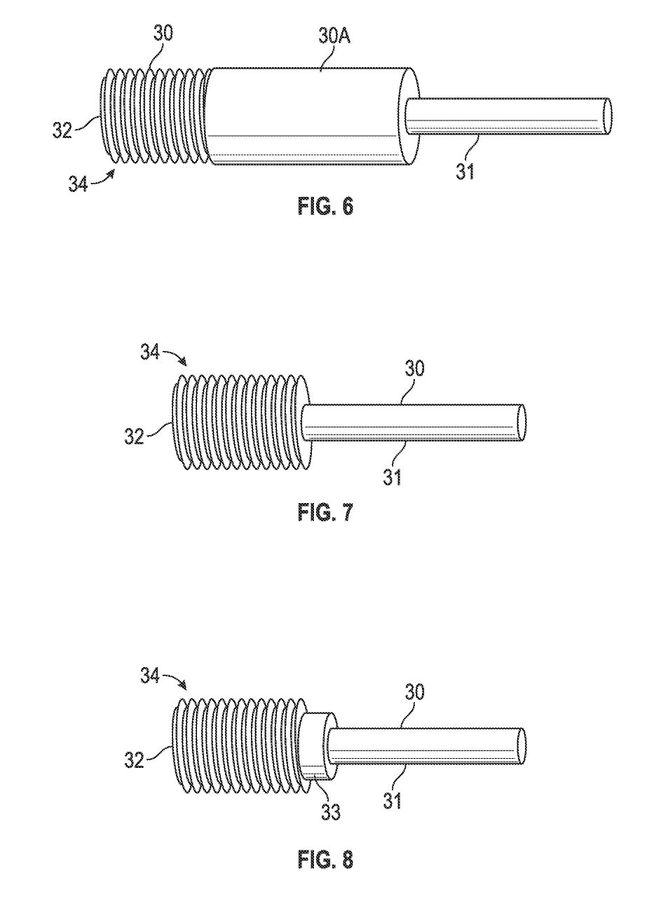

Shell casing 20 is fitted over pin 30 and sleeve 40. Pin 30 remains within the recessed bore 4 or hub 1, sleeve 40 remains over a portion of pin 30. As shown in FIG. 3A, pin back 35 extends into vacant primer location, now cylindrical empty core 24 on shell casing back 22. Pin shaft 31 edge (not marked) is shaped and sized to conform as close as possible to diameter of hole 24 so that rim 23 mates evenly with shaft 30. The exactness of fit, in and of itself, can hold shell casing to pin. Otherwise, glue, silicone, etc. may be used to affix the pieces. As in recycling bullet casings, shell casing 20 via forward opening 21, is crimped around sleeve 40 to ensure a tight and holding fit. As in this case and throughout the embodiments any contact bare, threaded, flat, may also include glue, silicone, or other fixing or lubricating means. If preferred, neck 33 includes extended portion 30A, with a wider diameter than pin shaft 31, to and through shell casing opening 21 so that crimping secures shell casing and sleeve to pin via neck 33. In an alternative embodiment, where the sleeve is to imitate a full metal jacket with sloping narrowing point, pin neck 33 does not extend at the same width to/through shell casing, but still allows crimping by sleeve. As shown in alternative embodiment of FIG. 8, pin 30 includes head 34 and successively shorter diameter neck 33 to diameter of shaft 31. Head 34 is inserted wholly into recess of the hub leaving a partially wider neck 33 for crimping of sleeve thereon to provide a narrowing look when the bullet handle is attached.

As shown in FIG. 6, neck extended portion 33A extends at a similar diameter to head 34 to allow direct crimping with no intended drop off or narrowing at the head.

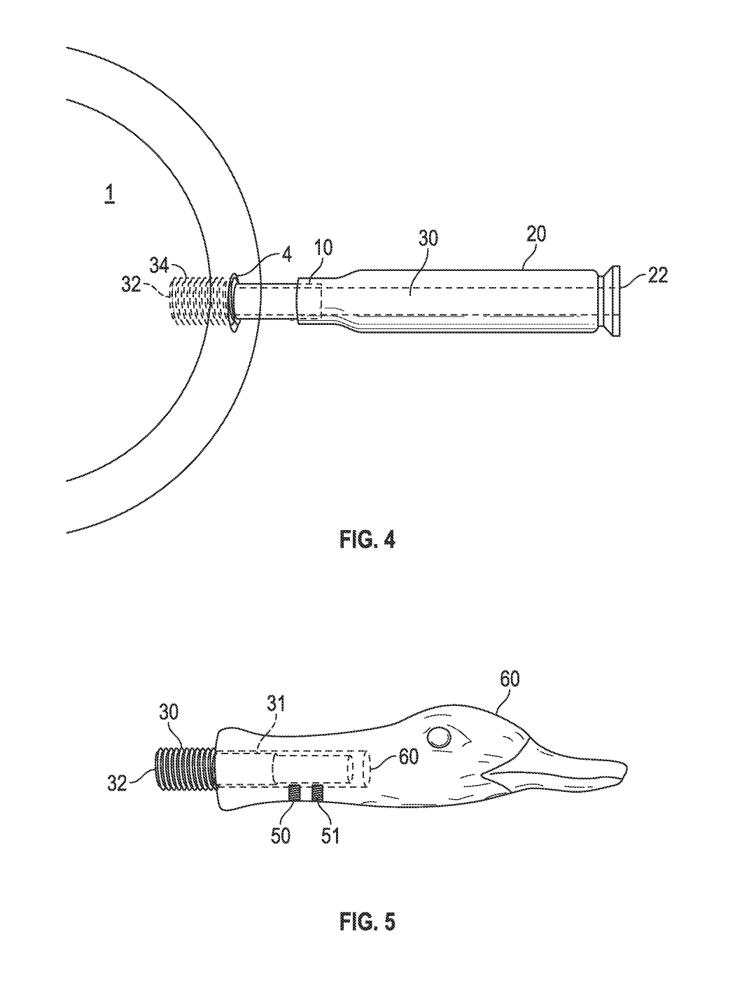

FIG. 4 demonstrates an assembled embodiment. Pin 30 head 34 is inserted into bore 4 of hub 1, neck as in embodiment shown in FIG. 6 extends beyond hub edge and is encircled by sleeve 40, which is in turn held together by shell 20. Pin 30 extends through shell casing 20 to back end 22.

FIG. 7. demonstrates an additional embodiment of pin 31 that is most useful for handle embodiments that do not require crimping. FIG. 8 demonstrates a pin 30 orientation with slimmed unthreaded head portion 33.

For instance, as shown in embodiment of FIG. 5, pin 30 is used to hold alternative handle ornamentation, such as a duck head handle 60. Pin shaft 31 extends through channel 61 within handle 60. Handle 60 is affixed in a specific orientation to pin 30 via a set screw 50 through set screw inset 51. Inset 51 preferably includes mating threads to hold screws 50.

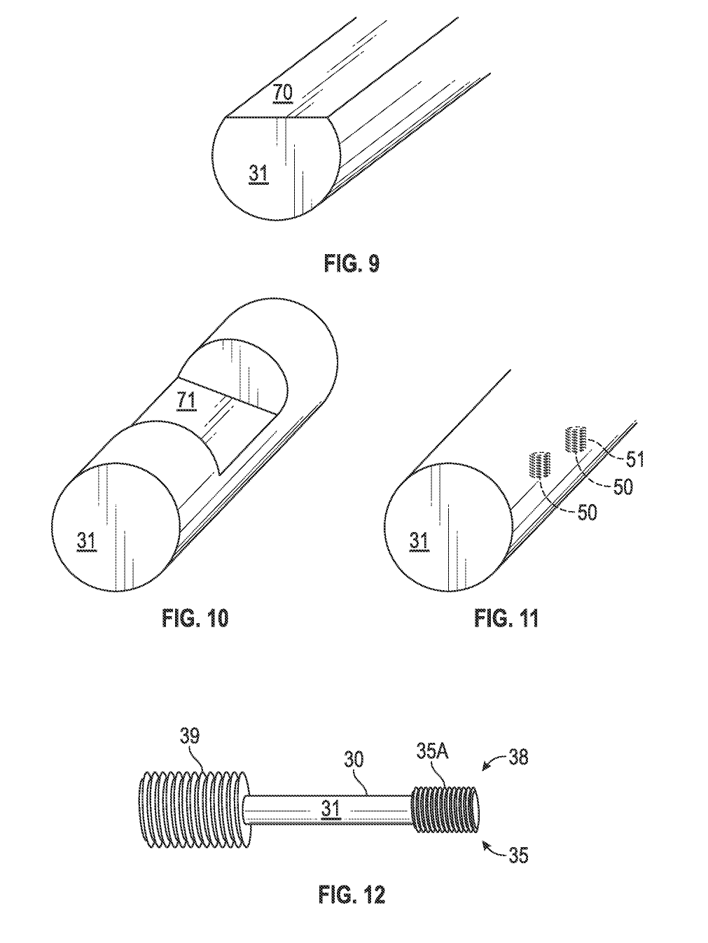

FIGS. 9 through 11 show alternate versions of pin shaft 31 shaped and/or designed to conform to various handle ornaments. For instance, shaft 31 may have an elongated flat section 70 that spans all or most of the shaft length beyond the head. Creating a flat section thus saves some machining time, energy and cost. For instance, a single cut can be made, or a shaft can be constructed thus and mated/paired with a shaft head. The flat surface makes for easier and more surface area contact with the set crews or other fastener utilized to match and hold ornamental handle with shaft and pin. A flat bottom screw can thus contact the flat section 70. This configuration requires that the pin be screwed in the right number of degrees so as to allow the flat section 70 to orient in the proper direction for the ornamental design. For instance, an ornamental handle may only work or look best in one orientation, so that the pin must be turned to hide or show the set screw. The orientation of most hub bores is offset at more than 10 degrees from gun safe face plane making set screw installation toward the face easy, or made easier with use of an L-wrench or other corner utilizing wrench driver/tool. An alternative configuration of shaft might be in a square or hex (or any polynomial) to allow for multiple flat surfaces. Another alternative may be in the embodiment configured in FIG. 10 whereby a set portion 71 either directly off head or offset by a set measure, i.e. ½ inch may be utilized. A single cut, as shown, may be cheapest easiest to manufacture, but hex, square triangle, etc. may be employed.

Depending on ornamentation, and use of set screws, a shaft such as that shown in FIG. 11 may be employed with complementary threaded bores for receipt of a set screw set through the ornamental handle.

In an alternative embodiment of a shaft, as shown in FIG. 12, shaft head 34 is threaded and sized to mate with hub bore. Extending shaft 31 may be the same, larger or smaller in size, preferably smaller diameter, and extend beyond bore. The back end 35 may include a set of threads 35A for mating with another female threaded section (or vice versa wherein back end has its own bore hole with threads). Preferably the threads 35A run in opposite direction and mate with threads in the ornamental handle. By reversing the thread direction the single direction screwing will reinforce the screwing in of the shaft into the hub bore and secure a handle. In an alternative, threads run in the same direction.

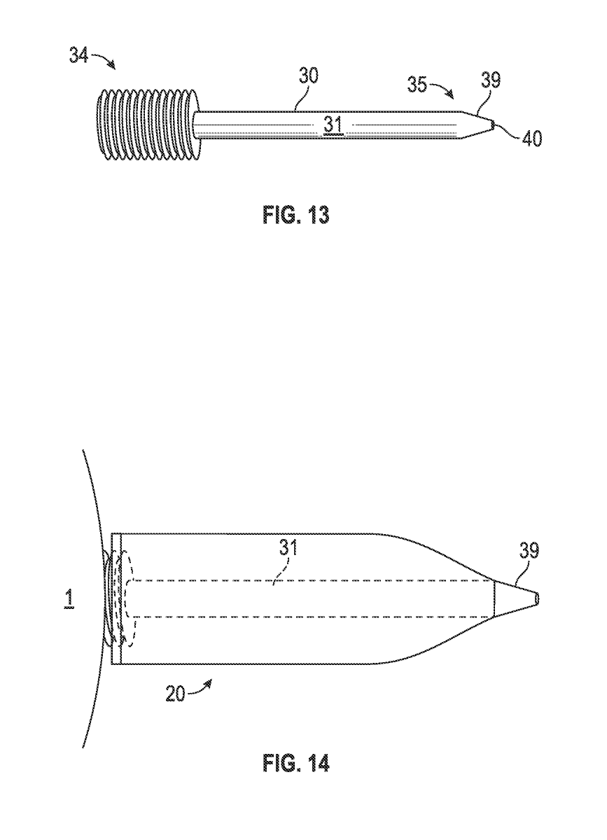

In an alternative embodiment of pin 30 as shown in FIG. 13, pin 30 includes head 34 and shaft 21. At back end 35, pin back tapers in ornamental section 39 with end 40. Preferable, sections 39 and end 40 are made to resemble a bullet and bullet tip, respectively. As shown in FIG. 14, when assembled and installed into hub 1, bullet casing 20 fits over pin shaft 31, leaving remaining section 39 so as to emulate a bullet pointed away from hub. The same and varied material and color and shapes consideration described above is applied to this embodiment.

Threads are made in a thickness and width to match normal standard threads currently utilized in gun safe axle bores as known in the art. It is contemplated that the shafts will come with two head thread sizes, one for American standard, and another for metric as employed in the international gun safe manufacturing community. The term “substantially”, i.e. parallel and perpendicular, etc. refer to angles less than 15%, preferably less than 5%, or more preferably less than 2% off the standard perfect measure.

I claim:

1. A gun safe for storing firearms and other valuables, said gun safe comprising an opening for access to stored contents contained within said safe, said opening comprising a door, said door comprising locking mechanism for locking and unlocking said safe door, said locking mechanism comprising:
a) a rotatable axis for activating a door locking mechanism;
b) said rotatable axle comprising an exposed hub on an outer surface of said safe;
c) said hub comprising at least one female threaded cavity for installment of at least one handle pin,
d) said handle pin comprising;
(1) a head at a first end, at least a portion of said head comprising male-threads, said head coupled to said hub;
(2) an elongated shaft forming the second end of said pin, said shaft comprising a distal end; and
(3) an neck portion situated between said head and said shaft, said neck comprising a neck diameter and neck length; and
d) at least one cover piece coupled to said handle pin.

2. The gun safe of claim 1, said cover piece comprising:
a) a first sheath comprising a diameter greater than said neck diameter so as to fit said first sheath over said neck;
b) said first sheath comprising a length greater than said pin neck length, said first sheath covering a at least a portion of said pin elongated shaft;
c) an second ornamental sheath comprising a diameter greater than said first sheath diameter to fit said second sheath over at least a portion of said first sheath;
d) said pin elongated shaft extending through at least a major portion of said second sheath.

3. The gun safe of claim 2, said second ornamental sheath comprising a bullet casing, said bullet casing comprising a first open end to fit over and install onto said handle pin;

4. The gun safe of claim 3, wherein said bullet casing is repurposed from a used functional bullet.

5. The gun safe of claim 3, wherein said bullet casing further comprising as back end opposite said first open end; said back end comprising an aperture.

6. The gun safe of claim 5, wherein said aperture is sized to complimentarily fit said handle pin shaft, so as to allow said pin shaft distal end to imitate a center-fire primer pocket on a bullet.

7. The gun safe of claim 1, said cover piece comprising an ornamental handle, said ornamental handle comprising:
a) an interior cavity formed to fit over said handle pin; and
b) an outer surface for access by a user.

8. The gun safe of claim 7, further comprising:
a) said elongated shaft comprising a longitudinal axis emanating from said hub; and
b) said cover piece further comprising at least one access cavity comprising an axis substantially perpendicular to said handle pin elongated shaft longitudinal axis;

9. The gun safe of claim 8, where said cover piece access cavity comprises a threaded surface.

10. The gun safe of claim 9, wherein said handle pin comprising an outer surface, wherein at least a portion of said handle pin outer surface comprising a flattened surface.

11. The gun safe of claim 7, wherein said handle pin elongated shaft distal end comprises a threaded surface; and wherein said cover piece access cavity comprises complimentary threaded surface for mating with said handle pin distal end threaded surface.

12. The gun safe of claim 7 wherein said handle pin elongated shaft distal end comprises an ornamental tip.

13. The gun safe of claim 12 wherein said ornamental tip comprises a tapering tip reminiscent of a bullet tip.

14. The gun safe of claim 13 where said cover piece comprises a bullet casing.

15. A method for enhancing the appearance and ornamentation of a gun safe, said method comprising the steps of:
a) mating a threaded pin head into a gun safe rotating handle hub, while exposing at least a portion of the pin beyond the hub;
b) placing a first sheath over at least a portion of the exposed pin;
c) placing a second sheath over at least a portion of the first sheath;
d) crimping the second sheath over the first sheath and onto the pin.

16. The method of claim 15 wherein said second sheath covers the first sheath at the at least portion of the exposed pin.

17. The method of claim 15 further comprising the step of crimping the first sheath to said pin prior to step d) of crimping the second sheath.

18. A method for enhancing the appearance and ornamentation of a gun safe, said method comprising the steps of:
a) mating a threaded pin head into a gun safe rotating handle head
b) placing an ornamental sheath over the pin;
c) securing the ornamental sheath via at least one set screw extending through an outside edge of the ornamental sheath; and
d) mating the at least one set screw with a surface of the pin.

19. The method of claim 18 further comprising the steps of:
a) Securing the ornamental sheath with at least a second set screw; and
b) Mating the at least second set screw with a surface of the pin.

20. The method of claim 18 further comprising the step of securing the ornamental sheath over the pin via thread included within the ornamental sheath with complimentary threads on an exterior surface towards the distal end of the pin.
